(19) United States
(12) Patent Application Publication
(10) Pub. No.: US 2019/0373021 A1
(43) Pub. Date: Dec. 5, 2019

(54) POLICY AGGREGATION

(71) Applicant: Nutanix, Inc., San Jose, CA (US)

(72) Inventors: Ranjan PARTHASARATHY, Milpitas, CA (US); Rajesh P. BHATT, San Jose, CA (US); Binny Sher GILL, San Jose, CA (US); Viraj SAPRE, Sunnyvale, CA (US); Rajkumar Singh, Bangalore (IN)

(73) Assignee: Nutanix, Inc., San Jose, CA (US)

(21) Appl. No.: 16/195,368

(22) Filed: Nov. 19, 2018

Related U.S. Application Data
(60) Provisional application No. 62/588,880, filed on Nov. 20, 2017.

(51) Int. Cl. H04L 29/06; G06F 9/455

(52) U.S. Cl. CPC H04L 63/20; G06F 2009/45579; G06F 9/45558

(57) ABSTRACT

Systems and methods for aggregating policies to enforce on computing entities of a computing system. A method embodiment commences upon administrative definition of a set of named policy associations that are applicable to various types of such computing entities. The occurrence of two or more named policy associations that are associated with a particular computing entity cause the policies to be processed to detect and reconcile possible conflicts. Reconciliation is accomplished by applying a set of conflict resolution rules. The result of detection and reconciliation of conflicts is a policy aggregate that comprises two or more non-conflicting policy subcomponents. During ongoing uses of the computing entities, policy actions are taken so as to enforce the semantics of the policy subcomponents onto the computing entity. When the computing system undergoes changes that could affect the policy assignments and/or enforcement semantics of the underlying policy subcomponents, the reconciliation process is repeated.

### RELATED APPLICATIONS

The present application claims the benefit of priority to U.S. Patent Application Ser. No. 62/588,880 titled “POLICY AGGREGATION”, filed on Nov. 20, 2017, which is hereby incorporated by reference in its entirety.

This disclosure relates to distributed computing, and more particularly to techniques for applying aggregated policies over computing entities.

### BACKGROUND

In virtualized computing systems, computing entities can take on associations to one or more policies that are established by a user (e.g., system administrator), a computing system vendor, and/or another party. For example, a virtual machine might have an association with a networking policy that defines various network usage permissions, limitations or other constraints (e.g., only port 8080 is permitted to be used). The virtual machine may further have associations to many other types of policies, such as policies pertaining to security (e.g., limits, etc.), data replication (e.g., backups, snapshots, etc.), resource usage (e.g., usage limits, quotas, etc.), and/or other policy areas.

At some time after an initial association is made, the environment and/or purpose of that same virtual machine may change such that a different combination of policies becomes appropriate (e.g. port 8080 becomes closed and port 4692 becomes open and permitted to be used). As time progresses, the number of individual policies increases, and a computing entity might accordingly need comport with more and more of these individual policies. In some cases, a single computing system might host many computing nodes that in turn host hundreds or thousands of computing entities (e.g., virtual machines, executable containers, virtual disks, etc.) which in turn might refer to large numbers of individual policies.

Unfortunately, as the number of computing entities and individual policies in a virtualized computing system increases, so does the administrative burden to manage the computing entities and their corresponding policies. One possible approach to administer computing systems is to rely on one or more system administrators to select an appropriate set of individual policies for each computing entity each and every time there is a change to the environment or entity, and/or each and every time there is a configuration change that does precipitate or potentially could precipitate an event that would affect the computing environment and/or entities within the computing environment

In large, highly-dynamic virtualized environments (e.g., in ever-changing environments and computing systems of a large enterprise) this approach is deficient. Specifically, the time lapse while waiting for system administrators to determine and assign the policies to each computing entity may create an unsatisfactory experience for the users of the computing entities. Such techniques also fail in that since system administrators are humans, they are susceptible to policy selection and/or assignment errors, which can result in serious consequences (e.g., security breach, data loss, etc.). Furthermore, when adding multiple individual policies to a computing entity, policy attribute conflicts often arise, and the system administrators are still further burdened to identify and resolve such conflicts. What is needed is a technological solution to reduce or eliminate the policy management burdens on system administrators while still permitting flexible assignments between computing entities and their respective sets of policies.

### SUMMARY

The present disclosure describes techniques used in systems, methods, and in computer program products for policy aggregation, which techniques advance the relevant technologies to address technological issues with legacy approaches. More specifically, the present disclosure describes techniques used in systems, methods, and in computer program products for performing entity-specific aggregation of policies that are enforceable on computing entities in virtualized computing environments. Certain embodiments are directed to technological solutions for forming a tier of named policy associations that are assigned to computing entities for automated management of entity-specific policy aggregates and their relationships to individual policy constituents in rapidly-changing computing environments. Some embodiments form a set of named policy associations that are assigned to computing entities to facilitate generation of entity-specific policy aggregates for the computing entities

The disclosed embodiments modify and improve over legacy approaches. In particular, the herein-disclosed techniques provide technical solutions that address the technical problems attendant to managing large numbers of individual policies that are assigned to large numbers of computing entities in virtualized computing environments. Such technical solutions relate to improvements in computer functionality. Various applications of the herein-disclosed improvements in computer functionality serve to reduce the demand for computer memory, reduce the demand for computer processing power, reduce network bandwidth use, and reduce the demand for inter-component communication. Some embodiments disclosed herein use techniques to improve the functioning of multiple systems within the disclosed environments, and some embodiments advance peripheral technical fields as well. As one specific example, use of the disclosed techniques and devices within the shown environments as depicted in the figures provide advances in the technical field of computing policy management as well as advances in various technical fields related to computing cluster administration.

Further details of aspects, objectives, and advantages of the technological embodiments are described herein, and in the drawings and claims.

### BRIEF DESCRIPTION OF THE DRAWINGS

The drawings described below are for illustration purposes only. The drawings are not intended to limit the scope of the present disclosure.

FIG. 1A illustrates a computing environment in which embodiments of the present disclosure can be implemented.

FIG. 1B illustrates a mapping between individual policies and computing entities through a policy association tier, according to one embodiment.

FIG. 2 depicts a policy aggregation technique as implemented in systems that facilitate entity-specific aggregation of policies that are enforced on computing entities in virtualized computing environments, according to an embodiment.

FIG. 3A exemplifies a centralized policy framework implementation for systems that support entity-specific aggregation of policies in virtualized computing environments, according to some embodiments.

FIG. 3B exemplifies a distributed policy framework implementation for systems that support entity-specific aggregation of policies in virtualized computing environments, according to some embodiments.

FIG. 4 presents an administrative management technique for maintaining several specialized data structures that are designed to improve the way that a computer stores and retrieves data in memory when performing techniques pertaining to assignment and enforcement of policies in virtualized computing environments, according to an embodiment.

FIG. 5 depicts a policy aggregate generation technique as implemented in systems that facilitate entity-specific aggregation of policies that are enforced on computing entities in virtualized computing environments, according to an embodiment.

FIG. 6A and FIG. 6B illustrate a policy aggregate application scenario as implemented in systems that facilitate entity-specific aggregation of policies that are enforced on computing entities in virtualized computing environments, according to some embodiments.

FIG. 7 presents a distributed virtualization system in which embodiments of the present disclosure can be implemented.

FIG. 8 depicts system components as arrangements of computing modules that are interconnected so as to implement certain of the herein-disclosed embodiments.

FIG. 9A, FIG. 9B, and FIG. 9C depict virtualized controller architectures comprising collections of interconnected components suitable for implementing embodiments of the present disclosure and/or for use in the herein-described environments.

### DETAILED DESCRIPTION

Embodiments in accordance with the present disclosure address the problem of managing large numbers of individual policies that are assigned to large numbers of computing entities in virtualized computing environments. Some embodiments are directed to approaches for forming a tier of named policy associations that are assigned to computing entities for automated management of entity-specific policy aggregates and their relationships to individual policy constituents. The accompanying figures and discussions herein present example environments, systems, methods, and computer program products for performing entity-specific aggregation of policies that are enforced on computing entities in rapidly-changing computing environments.

### Overview

Disclosed herein are techniques for forming a tier of named policy associations for use by computing entities. The named policy associations facilitate generation of entity-specific policy aggregates comprising groups of individual, non-conflicting lower-tier policies for the computing entities. In certain embodiments, the individual policies (e.g., policy subcomponents) that comprise the various policy aggregates contain certain mapping rules that map the individual policies to one or more named policy associations. One or more of these named policy associations, which correspond to respective entity operational characteristics, are assigned to a computing entity.

When a create or update event for the computing entity is detected, the then-current named policy associations that are assigned to the computing entity are identified. The mapping rules of the individual policies are applied to the identified named policy associations to determine the policy aggregate for the computing entity. The policy aggregate is then enforced over the computing entity. In certain embodiments, conflicts between the individual policies in the policy aggregate are automatically identified and resolved. In certain embodiments, the mapping rules comprise one or more policy actions associated with the individual policies that are executed to enforce the individual policies on the computing entities. In certain embodiments, a rule base is implemented to identify and/or resolve the conflicts. In certain embodiments, the named policy associations are assigned to the computing entities using a specialized data structure associated with the entities. In certain embodiments, the mapping rules are codified using specialized data structures associated with the individual policies.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### DESCRIPTIONS OF EXAMPLE EMBODIMENTS

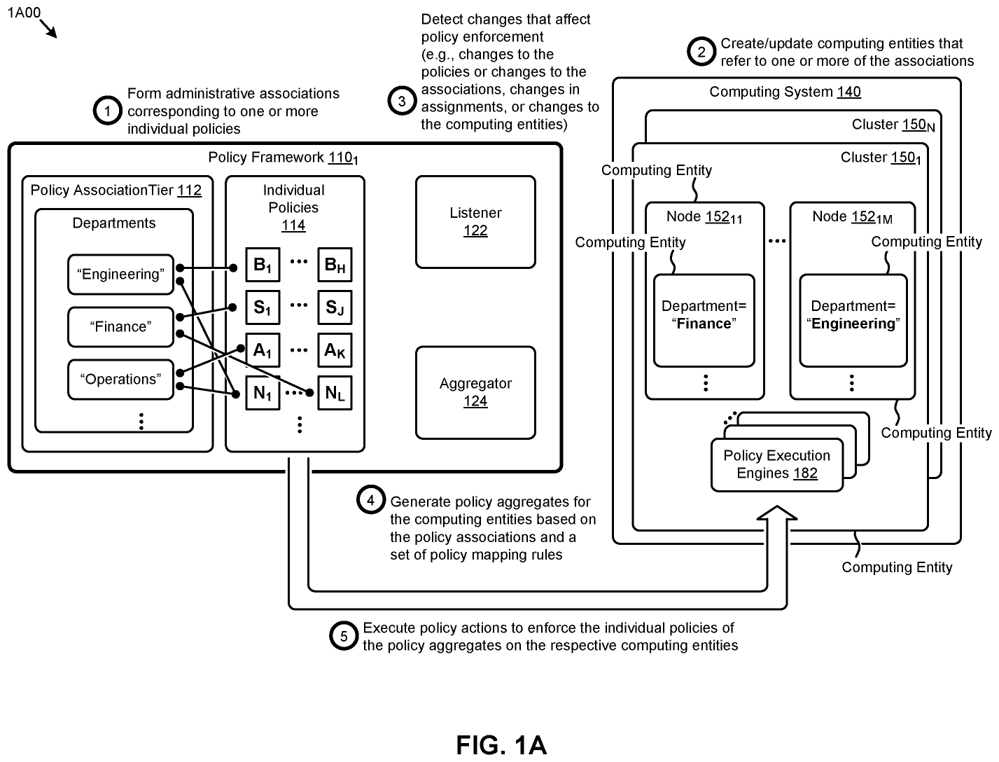

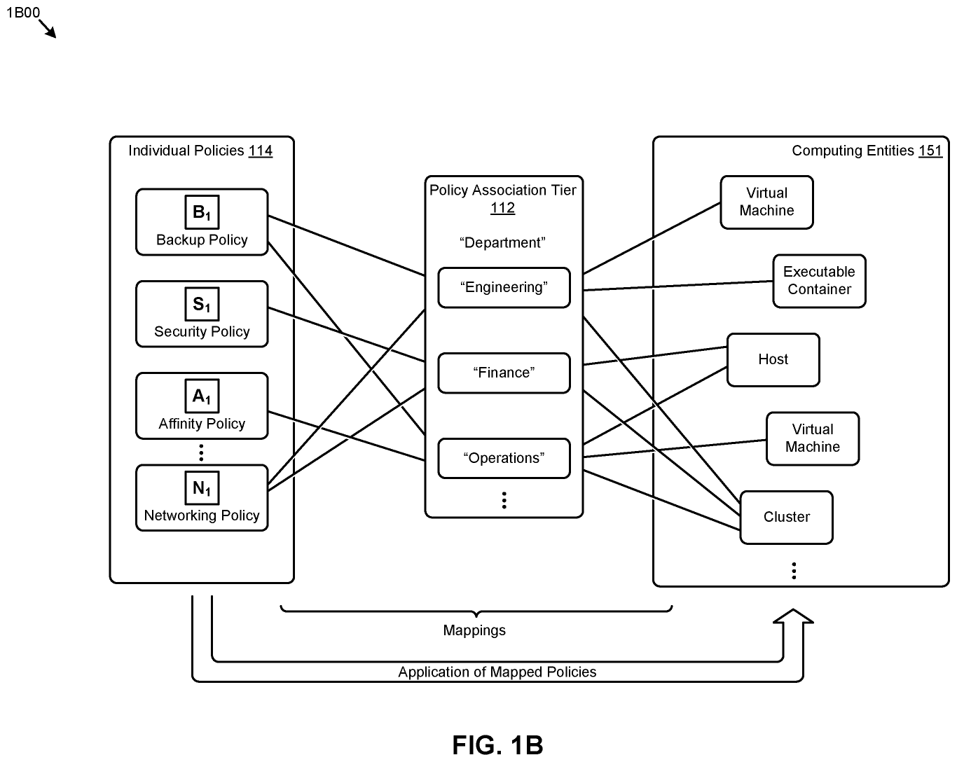

FIG. 1A illustrates a computing environment 1A00 in which embodiments of the present disclosure can be implemented. As an option, one or more variations of computing environment 1A00 or any aspect thereof may be implemented in the context of the architecture and functionality of the embodiments described herein.

The diagram shown in FIG. 1A is merely one example of a computing environment 1A00 in which the herein disclosed techniques for policy aggregation can be implemented. As shown, computing environment 1A00 comprises a virtualized computing system 140 that in turn comprises various computing entities. Specifically, virtualized computing system 140 comprises multiple computing clusters (e.g., cluster 150₁, . . . , cluster 150_{N}) that each comprise computing nodes (e.g., node 152₁₁, . . . , node 152_{1M}). The nodes can host other computing entities, such as virtual machines or executable containers. As earlier mentioned, the computing entities can take on associations to one or more individual policies 114. The individual policies 114 can comprise policies that pertain to data replication (e.g., backup policy B₁, . . . , backup policy B_{H}), security (e.g., security policy S₁, . . . , security policy S_{J}), affinity (e.g., affinity policy A₁, . . . , affinity policy A_{K}), networking (e.g., networking policy N₁, . . . , networking policy N_{L}), and/or other functional and/or operational aspects of a computing entity. As an example, such individual policies might constrain the operation of a computing entity (e.g., only port 80 can be used by the entity) and/or associate a certain function with a computing entity (e.g., perform a daily backup of the entity).

As time progresses, the number of the individual policies 114 increases, and the computing entities in virtualized computing system 140 might accordingly need to form associations to more and more of these individual policies 114. The virtualized computing system 140 might host hundreds or thousands of computing entities (e.g., clusters, nodes, virtual machines, executable containers, virtual disks, etc.) which in turn might refer to large numbers of individual policies.

Some approaches to managing the associations between the computing entities in virtualized computing system 140 and the individual policies 114 rely on one or more system administrators to select an appropriate set of the individual policies 114 for each computing entity. In large, highly-dynamic virtualized environments (e.g., in ever-changing environments and computing systems of a large enterprise) this approach is deficient at least as pertains to the time lapse incurred while waiting for system administrators to determine and assign the policies to each computing entity. Such manual (e.g., administrator-implemented) approaches may also result in erroneous and/or conflicting policy selections and/or assignments.

The herein disclosed techniques provide a technological solution to the foregoing deficiencies. Specifically, as illustrated in the embodiment of FIG. 1A, a policy framework 110₁ can be implemented to form a tier of named policy associations that are assigned to the aforementioned computing entities to facilitate generation of entity-specific policy aggregates for enforcement on the computing entities. More specifically, a policy association tier 112 is formed to comprise various named policy associations that correspond to respective computing entity operating characteristics.

The examples shown depict named policy associations that correspond to a department (e.g., “Engineering”, “Finance”, “Operations”, etc.) that might be associated with a particular computing entity. Other policy associations can correspond to other computing entity operational characteristics (e.g., access tiers, user roles, entity lifecycles, etc.). A set of policy mapping rules are then codified in the definitions of the individual policies 114 (operation 1). The mapping rules serve to associate each of the individual policies 114 or policy subcomponents to one or more of the named policy associations. In certain embodiments, the mapping rules may also specify one or more policy actions that can be executed to fulfill a respective individual policy. Assignments to certain named policy associations are associated with each of the computing entities when the entities are created and/or updated (operation 2). For example, the “Engineering” policy association might be assigned to a virtual machine that is created for operation by an engineer working in the Engineering Department.

A listener 122 from the policy framework 110₁ can monitor changes in virtualized computing system 140 to detect any alterations to the policy association(s), and/or changes to the individual policies or their subcomponents, and/or changes made to the computing entities (operation 3). For example, a change might occur as a result of the creation or update of a computing entity. Responsive to detecting such a change, an aggregator 124 from the policy framework 110₁ generates a reconciled policy aggregate that comprises one or more of the individual policies, where the aggregate is formed based at least in part on the named policy association assignments of the computing entity and the mapping rules of the individual policies 114 (operation 4).

In some cases, the aggregator 124 might reconcile by resolving conflicts (e.g., by selecting a dominating policy characteristic) and/or by suppressing duplicates (e.g., by eliminating redundant actions) as might be found between the individual policies that comprise a particular policy aggregate. Certain policy actions are then executed to enforce the individual policies of the policy aggregates on the respective computing entities (operation 5). As shown, in this particular embodiment, policy actions can be executed by a set of policy execution engines 182 (e.g., corresponding to each policy type) at the virtualized computing system 140. Any redundant policy actions that have already been applied can be removed (e.g., by aggregator 124) from the set of policy actions are issued for execution. The example of FIG. 1A illustrates how selected individual policies that comprise the policy aggregates for the various computing entities in virtualized computing system 140 are enforced over virtual machines. Specifically, policies S₁ and N_{L} are enforced on the “Finance” virtual machine at node 152₁₁, due to that virtual machine being assigned to “Department/Finance”. Policies B₁ and N₁ are enforced on the “Engineering” executable container at node 152_{1M} due to that virtual machine being assigned to “Department/Engineering”.

The techniques discussed as pertains to FIG. 1A and elsewhere herein facilitate improvements in computer functionality as compared to other approaches. Specifically, rather than reviewing the entire corpus of individual policies 114 to apply to a computing entity each time one is created or updated (e.g., repurposed), the herein disclosed techniques automatically generate policy aggregates to apply to the computing entities, while also resolving policy conflicts and eliminating policy actions that have already been applied. This approach reduces the consumption of processing resources, storage resources, networking resources, and/or other computing resources as compared to the resources consumed by the policy selection, conflict resolution, and enforcement techniques of previous approaches. Implementing the herein disclosed techniques for policy aggregation further improves the experience and productivity of the administrators and/or users of computing entities that are associated with numerous policies.

FIG. 1B illustrates a mapping 1B00 between individual policies and computing entities through a policy association tier. The shown policy association tier 112 refers to various “Departments” (e.g., “Engineering”, “Finance”, Operations”) each of which have assignments of individual policies. As shown, “B1” and “N1” are associated to the “Engineering” department, and individual policies “S1” and “NL” are associated to the “Finance” department, and individual policies “A1” and “B1” are associated to “Operations”. The shown mappings are formed between computing entities 151 and one or more of the policy associations that constitute the policy association tier. Logic as is disclosed herein uses the aforementioned associations such that the actions or requirements that correspond to the individual policies that are mapped into a particular computing entity are enforced. This is shown schematically by the arrow labeled “Application of Mapped Policies”.

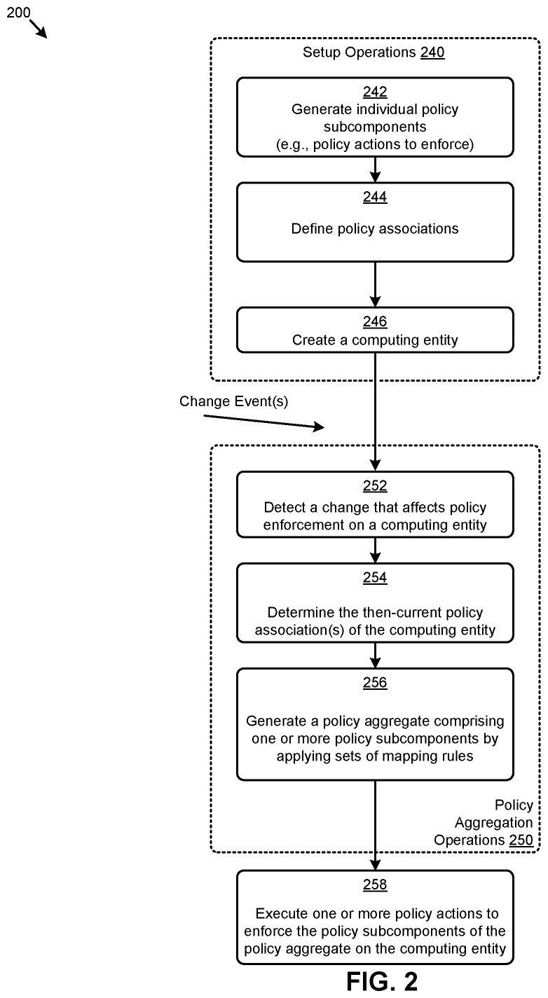

It is possible that multiple individual policies are mapped into a particular computing entity through the policy association tier 112. When multiple individual policies are mapped into a particular computing entity, the multiple individual policies are aggregated in such a manner that any conflicts or duplications are reconciled. A particular policy aggregation technique is shown and described as pertains to FIG. 2.

FIG. 2 depicts a policy aggregation technique 200 as implemented in systems that facilitate entity-specific aggregation of policies that are enforced on computing entities in virtualized computing environments. As an option, one or more variations of policy aggregation technique 200 or any aspect thereof may be implemented in the context of the architecture and functionality of the embodiments described herein. The policy aggregation technique 200 or any aspect thereof may be implemented in any environment.

The policy aggregation technique 200 presents one embodiment of certain steps and/or operations that facilitate entity-specific aggregation of policies that are enforced on computing entities in virtualized computing environments. As shown, the steps and/or operations of the policy aggregation technique 200 can be grouped in a set of setup operations 240 and a set of policy aggregation operations 250. The setup operations 240 of the policy aggregation technique 200 can commence in step 242 by defining one or more individual policy subcomponents that correspond to entity operational characteristics (e.g., limits, quotas, access permissions, etc.). The flow proceeds by establishing policy associations to the individual policies (step 244). Establishing policy associations to the individual policies can be accomplished using any known technique, possibly using a user interface such as depicted by the mapping 1B00 of FIG. 1B to form policy associations between the individual policies and constituent elements of the policy association tier.

Individual policies may comprise policy subcomponents that reflect a lowest tier of policy enforcement granularity for a particular computing system. As an example, one or more policy subcomponents can be associated with a particular computing entity, and/or certain constraints and/or functions and/or operations pertaining to data replication, security, affinity, networking, and/or other operational characteristics of the computing entity. In step 246, computing entities are created. In some cases, a created computing entity might include an assignment to one or more of the policy associations. The creation of an entity raises a change event.

The policy aggregation operations 250 of the policy aggregation technique 200 can respond to a change event by continuously listening for and filtering for applicability of changes of various types. At some moment in time, step 252 will detect a change that affects policy enforcement. Examples of such detectable changes that affect policy enforcement include changes to the individual policies, and/or changes to policy associations, and/or changes to policy association assignments in a computing entity, and/or changes to the configuration of a computing entity that affects a policy (e.g., a change in a limit or quota or operating status, etc.).

In some cases, an individual policy might be defined so as to comprise actions to be taken when enforcing the policy. Upon detecting a change that affects policy enforcement (step 252), some embodiments apply a set of intra-policy rules to verify there are no conflicts in within the policy definition. For example, an intra-policy rule might disallow the policy action that states, “open port 80” in the case that there is another policy action in the same individual policy that states, “do not use port 80”. The foregoing is merely one example of a class of intra-policy rules that consider a particular attribute/value of one individual policy to determine if it overlaps or conflicts with a corresponding attribute/value of another individual policy.

At step 254, the then-current policy association(s) of the computing entity are determined. Step 256 serves to generate a policy aggregate comprising one or more policy subcomponents and/or policy actions by applying mapping rules. Thereafter, as shown by step 258, one or more policy actions to enforce the policy subcomponents of the policy aggregate are executed over the computing entity.

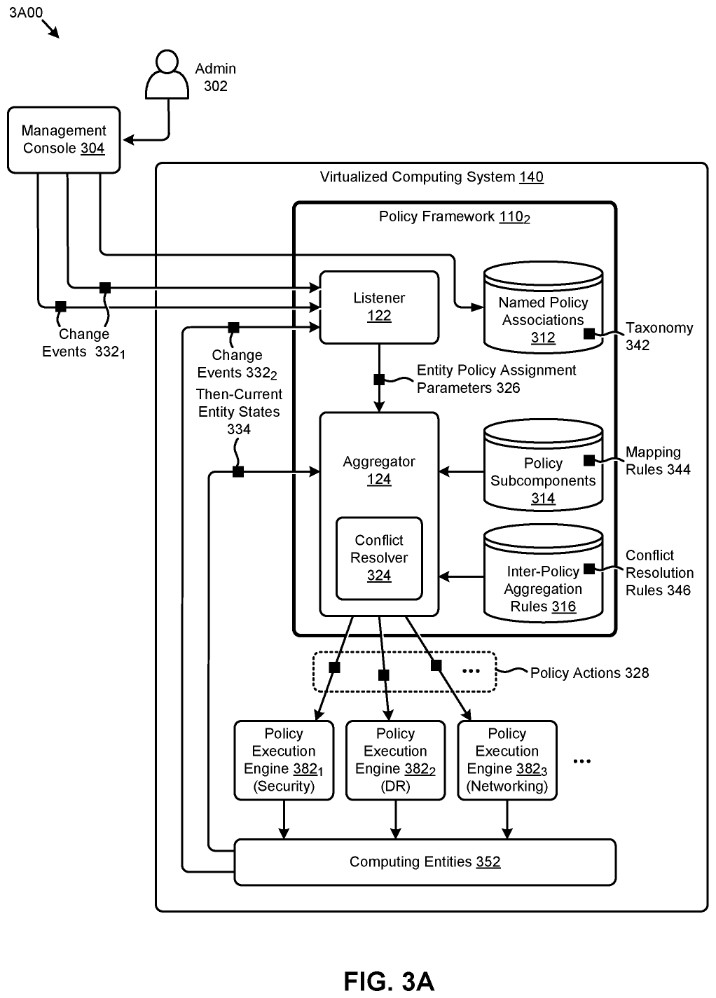

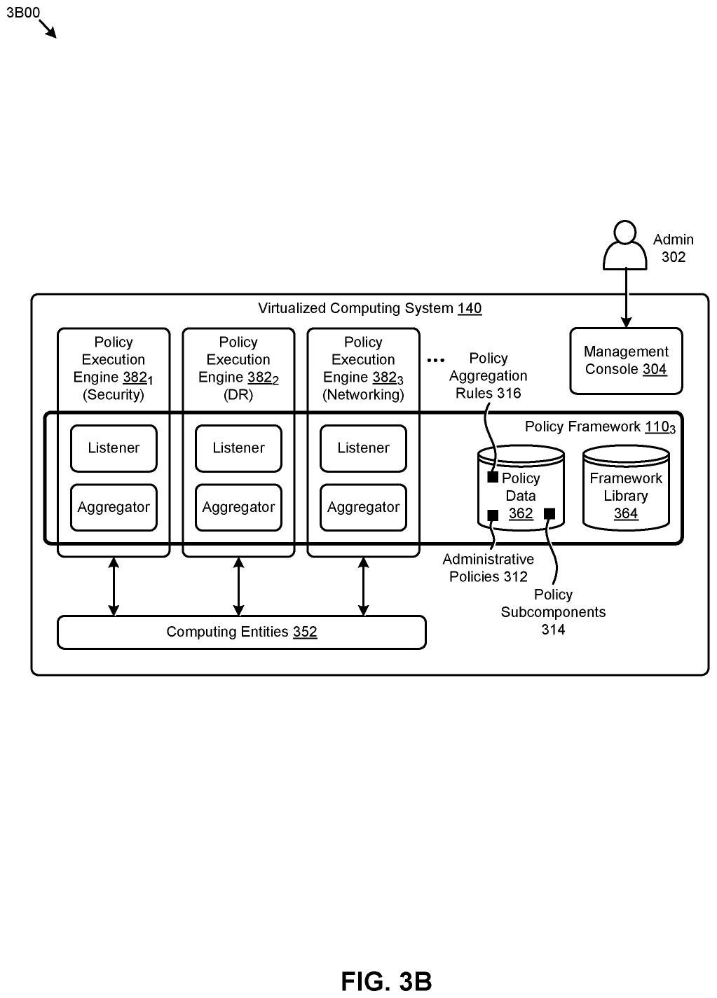

Detailed embodiments of a system, data flows, and data structures that implement the techniques disclosed herein are presented and discussed as pertains to the embodiments of FIG. 3A and FIG. 3B.

FIG. 3A exemplifies an embodiment having a centralized policy framework implementation 3A00 for systems that support entity-specific aggregation of policies in virtualized computing environments. As an option, one or more variations of centralized policy framework implementation 3A00 or any aspect thereof may be implemented in the context of the architecture and functionality of the embodiments described herein. The centralized policy framework implementation 3A00 or any aspect thereof may be implemented in any environment.

As shown in the embodiment of FIG. 3A, a centralized instance of the policy framework 110₂ is implemented in the virtualized computing system 140 to facilitate entity-specific aggregation of policies for a set of computing entities 352 in the system. The policy framework 110₂ comprises the listener 122 and the aggregator 124 earlier discussed. The policy framework 110₂ further includes datastores comprising data corresponding to a set of named policy associations 312, a set of policy subcomponents 314, and a set of inter-policy aggregation rules 316. As can be observed, the named policy associations 312 are described in accordance with a taxonomy 342. The taxonomy 342 is a strongly typed taxonomy that is established to facilitate the herein disclosed techniques. As an example, a system administrator (e.g., admin 302) might establish the taxonomy 342 and corresponding named policy associations 312 from a management console 304 at the virtualized computing system 140. In certain embodiments, the taxonomy 342 has a key-value structure with a strict set of keys and corresponding values.

The taxonomy 342 of the named policy associations 312 is consulted when codifying the named policy associations into the computing entities 352. For example, named policy associations are configured in compliance with the taxonomy. The listener 122 monitors for changes (e.g., change events 332₁, change events 332₂, etc.) such as changes to the policy associations and/or changes to individual policies, and/or changes to any aspect of the computing entities 352 that would at least potentially affect enforcement of policies. When a change event is detected, it is parsed and forwarded for aggregation processing. For example, when a change is detected at a particular computing entity (e.g., change from “PowerState”=“Off” to “PowerState”=“On”), the listener 122 forwards a set of entity policy assignment parameters 326 (e.g., policy association key-value pairs) corresponding to the computing entity to aggregator 124 for processing. The aggregator 124 applies the entity policy assignment parameters 326 to a set of mapping rules 344 associated with the policy subcomponents 314 to generate a policy aggregate for the computing entity. A set of rules (e.g., rule base) such as mapping rules 344 or any other rules described herein, comprises data records storing various information that can be used to form one or more constraints to apply to certain functions and/or operations.

For example, and as shown, the information pertaining to a rule in the rule base might comport with a mapping rule schema, which in turn might comprise the conditional logic operands (e.g., input variables, conditions, constraints, etc.) and/or operators (e.g., “IF”, “THEN”, “AND”, “OR”, “greater than”, “less than”, etc.) for forming a conditional logic statement that returns one or more results. According to the herein disclosed techniques, certain inputs (e.g., entity policy assignment parameters 326) are applied to mapping rules 344 to determine whether a policy subcomponent is to be included in a policy aggregate. For example, a logical expression involving an “OR” operator might result in multiple policy subcomponents from two individual policies being selected to be included in a policy aggregate.

In some cases, the mapping rules 344 might further identify one or more policy actions associated with the policy subcomponent. In some cases, the mapping rules 344 and/or policy subcomponents might be defined by admin 302 at the management console 304. In some cases, a management console 304 provided a graphical user interface for use be an admin (as shown). In certain embodiments, management console 304 executes scripts, possibly in a batch mode, or possibly interactively under admin control. In still other embodiments, operation of management console 304 might be completely under computer control using any known technique to create and/or configure, and/or update or otherwise make changes to individual policies and/or to make changes to any policy that affects any taxonomy or any policy subcomponent or any rule.

The aggregator 124 might consult the inter-policy aggregation rules 316 when generating the policy aggregates. As an example, a conflict resolver 324 at the aggregator 124 might access a set of conflict resolution rules 346 from the inter-policy aggregation rules 316 to resolve any conflicts between the policy subcomponents of a particular policy aggregate. The inter-policy aggregation rules 316 might themselves comprises constraints and/or logic to improve the efficiency of the aggregation process performed at aggregator 124. For example, if a first individual policy specifies a first quota to be enforced and a second individual policy specifies a second quota to be enforced, and the second quota is greater than the first quota, then only the limit pertaining to the second quota needs to be enforced.

When the aggregator 124 has generated the entity-specific policy aggregate comprising a set of individual, non-conflicting lower-tier policy subcomponents, a set of policy actions 328 are executed to enforce the policy aggregate at the computing entity. As shown, the policy actions 328 might be issued by the aggregator 124 to a set of policy execution engines (e.g., a policy execution engine 382₁ to execute “Security” policy actions, a policy execution engine 382₂ to execute data replication or “DR” policy actions, and a policy execution engine 382₃ to execute “Networking” policy actions) to enforce the policy aggregate over the computing entity. In certain embodiments, the aggregator 124 can monitor then-current entity states 334 to remove any redundant policy actions from the policy actions 328 that are determined to result in no change to the then-current entity state of the subject computing entity. In certain embodiments, any one or more of the set of policy execution engines might be implemented as a separate policy engine in a 1-to-1 mapping to particular policy actions (as shown), however in other embodiments, one or more of the policy execution engines might be implemented as a centralized service that relies in part on a framework library of code and data structure definitions.

The components, data flows, and data structures shown in FIG. 3A present merely one partitioning and associated data manipulation approach. The specific example shown is purely exemplary, and other subsystems and/or partitioning and/or data management approaches are reasonable. Specifically, the foregoing discussion of FIG. 3A describes a centralized implementation of a policy framework to facilitate the herein disclosed techniques. Other implementations of the policy framework are possible, one of which is disclosed in further detail as follows.

FIG. 3B exemplifies an embodiment of a distributed policy framework implementation 3B00 for systems that support entity-specific aggregation of policies in virtualized computing environments. As an option, one or more variations of distributed policy framework implementation 3B00 or any aspect thereof may be implemented in the context of the architecture and functionality of the embodiments described herein. The distributed policy framework implementation 3B00 or any aspect thereof may be implemented in any environment.

The embodiment of FIG. 3B depicts a distributed instance of the policy framework 110₃ that is implemented in the virtualized computing system 140 to facilitate entity-specific aggregation of policies for a set of computing entities 352 in the system. In the shown embodiment, instances of a listener and aggregator are implemented in each of the policy execution engines (e.g., policy execution engine 382₁, policy execution engine 382₂, and policy execution engine 382₃) at the virtualized computing system 140. Implementation of such instances of these and/or other functional components of the policy framework 110₃ is facilitated code and other objects that are provided in a framework library 364. Access to a centralized and/or distributed set of policy data 362 is also provided to facilitate the distributed policy framework implementation 3B00. As can be observed, the policy data 362 can comprise the named policy associations 312, the policy subcomponents 314, and/or all or portions of the earlier mentioned inter-policy aggregation rules 316, and/or other data used to facilitate the herein disclosed techniques. The admin 302 can access a management console 304 to interact with the policy framework 110₃ in the distributed policy framework implementation 3B00.

Certain embodiments of the herein disclosed techniques are facilitated by various specialized data structures which are disclosed in further detail as follows.

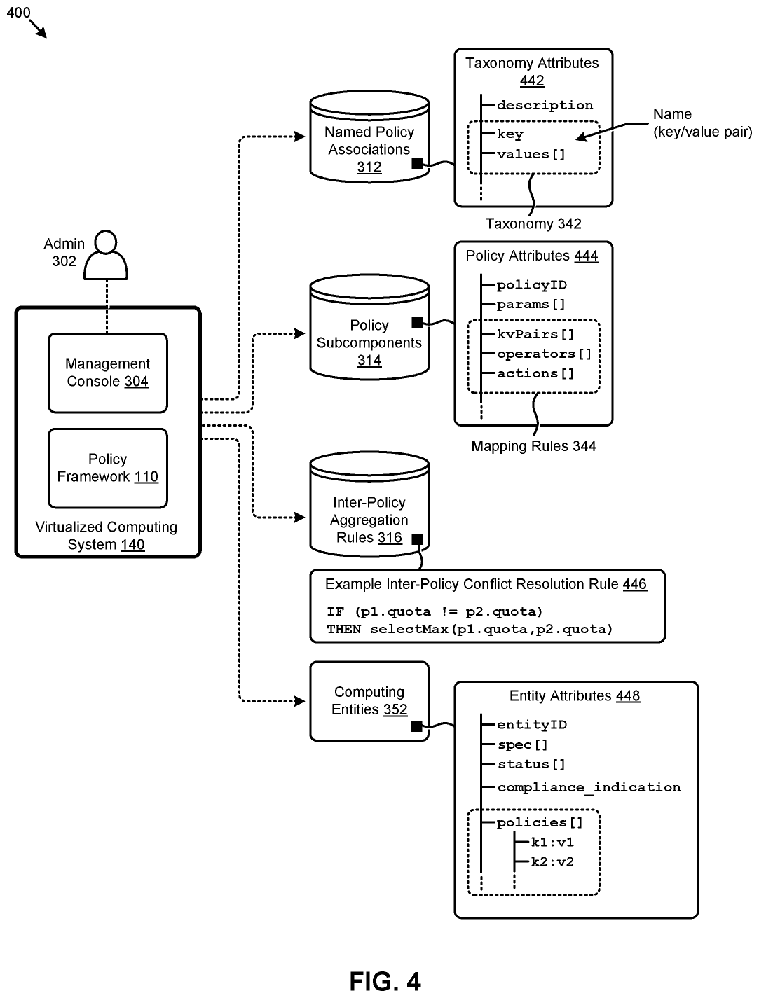

FIG. 4 presents an administrative management technique 400. The shown administrative function serves to manage several specialized data structures that are designed to improve the way that a computer stores and retrieves data in memory when performing techniques pertaining to assignment and enforcement of policies in virtualized computing environments. As an option, one or more variations of specialized data structures or any aspect thereof may be implemented in the context of the architecture and functionality of the embodiments described herein. The specialized data structures or any aspect thereof may be implemented in any environment.

The embodiment shown in FIG. 4 is merely one example technique for management of specialized data structures that can be implemented to facilitate entity-specific aggregation of policies that are enforced on computing entities in virtualized computing environments. As shown, the specialized data structures are associated with the named policy associations 312, the policy subcomponents 314, the inter-policy aggregation rules 316, and the computing entities 352 earlier described. In some cases, the content of the data structures can be manipulated (e.g., created, read, edited, deleted, etc.) by a user (e.g., admin 302) at a user interface (e.g., management console 304).

The specialized data structures and/or any other data structures described herein can be implemented using various techniques. For example, the taxonomy attributes 442 associated with the named policy associations 312 indicate that the named policy association data might be organized and/or stored in a tabular structure (e.g., relational database table) that has rows that relate various attributes with a particular named policy association. As another example, the information might be organized and/or stored in a programming code object that has instances corresponding to a particular named policy association and properties corresponding to the various attributes associated with the named policy association. Specifically, as depicted in taxonomy attributes 442, a data record (e.g., table row or object instance) for a particular named policy association might have a description (e.g., stored in a “description” field), a key portion of a key-value pair (e.g., stored in a “key” field), a list of possible values for the key (e.g., stored in a “values[ ]” object), and/or other attributes associated with the named policy association. As can be observed, the content in the “key” fields and “values[ ]” objects comprise the taxonomy 342 of the named policy associations 312, according to the shown embodiment.

The policy attributes 444 shown in FIG. 4 depict the information that describes each of a corresponding set of policy subcomponents 314. Specifically, the policy attributes 444 indicate that a data record (e.g., table row or object instance) for a particular policy subcomponent might describe a policy subcomponent identifier (e.g., stored in a “policyID” field), a list of one or more policy parameters (e.g., stored in a “params[ ]” object), a list of one or more named policy key-value pairs (e.g., stored in a “kvPairs[ ]” object), a set of one or more operators to apply to the key-value pairs (e.g., stored in an “operators[ ]” object), a list of one or more policy actions (e.g., stored in an “actions[ ]” object), and/or other attributes associated with the policy subcomponent. As can be observed, the content in the “kvPairs[ ]” object, the “operators[ ]” object, and the “actions[ ]” object comprise the mapping rules 344 of the policy attributes 444, according to the shown embodiment. In certain embodiments, a policy subcomponent can be defined (e.g., in its policy actions) to refer to one or more named policy associations.

As earlier described, the inter-policy aggregation rules 316 can include conflict resolution rules, duplicate suppression rules and/or other rules. The example inter-policy conflict resolution rule 446 illustrates one example of a conflict resolution rule that might be included in the inter-policy aggregation rules 316. Specifically, the example inter-policy conflict resolution rule 446 resolves a conflict in the “quota” parameter of two policy subcomponents (e.g., policy “p1” and policy “p2”). According to the example inter-policy conflict resolution rule 446, the maximum of the conflicting quota values is selected for enforcement over the associated computing entity or entities.

A specialized data structure associated with the entity attributes 448 of the computing entities 352 is also shown in FIG. 4. The entity attributes 448 indicate that a data record (e.g., table row or object instance) for a particular computing entity might describe an entity identifier (e.g., stored in a “entityID” field), a set of entity specifications (e.g., stored in a “spec[ ]” object), a set of entity status attributes (e.g., stored in a “status[ ]” object), a set of one or more occurrences of named policy associations (e.g., stored in a “policies[ ]” object), each of which occurrences comprises a respective one or more key-value pairs (e.g., each stored in a “key” field and a “value” field), and/or other attributes associated with the computing entity. As can be observed, the content in the “policies[ ]” object comprise the named policy associations of the computing entities 352, according to the shown embodiment. In some embodiments, the “status[ ]” object might include a compliance indication, which compliance indication is a Boolean value that indicates whether or not the entity is in compliance with the policies specified in a then-current set of policies (e.g., the policies in the “policies[ ]” object). In other embodiments, the entity attributes 448 includes a field or object such as the shown “compliance_indication” object to hold a value that indicates whether or not the entity is in compliance with a then-current set of policies.

The shown management console 304 can be implemented in a graphical user interface, such as is shown and described in FIG. 1B.

The data structures of FIG. 4 can be used in policy aggregate generation and/or application techniques as disclosed in further detail as follows.

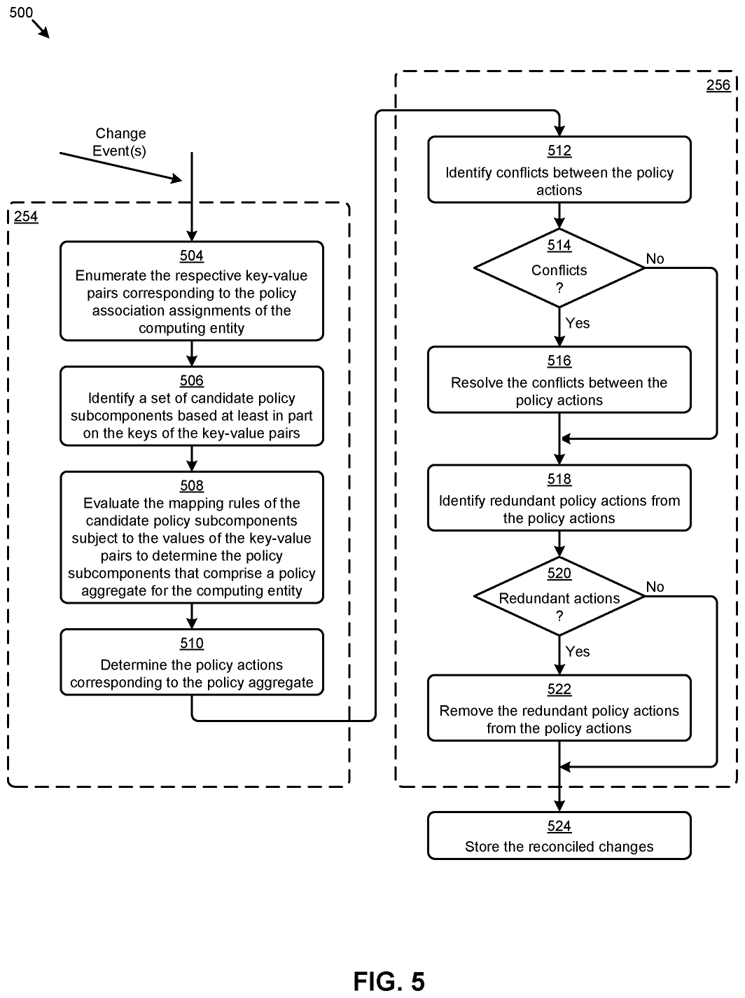

FIG. 5 depicts a policy aggregate generation technique 500 as implemented in systems that facilitate entity-specific aggregation of policies that are enforced on computing entities in virtualized computing environments. As an option, one or more variations of policy aggregate generation technique 500 or any aspect thereof may be implemented in the context of the architecture and functionality of the embodiments described herein. The policy aggregate generation technique 500 or any aspect thereof may be implemented in any environment.

The policy aggregate generation technique 500 presents one embodiment of certain steps and/or operations that facilitate generating entity-specific policy aggregates in accordance with the herein disclosed techniques. The shown steps and/or operations can represent one embodiment of the policy aggregation operations 250 of FIG. 2. As shown, the policy aggregate generation technique 500 can commence by detecting a change to a named policy association, and/or to assignments made into a computing entity, and/or to any other change in the computing entity. Such an event can occur at any moment in time for any computing entity.

As shown, the event invoked analysis of respective key-value pairs corresponding to the named policy association assignments of the computing entity are enumerated (step 504). A set of candidate policy subcomponents are identified based at least in part on the keys of the key-value pairs (step 506). For example, while forming a set of candidate policy subcomponents, a first individual policy of a particular named policy association might specify a first set of network ports, while a second individual policy of the named policy association might specify a second set of network ports. The mapping rules of the candidate policy subcomponents are then evaluated subject to the values of the key-value pairs to determine the policy subcomponents that comprise a policy aggregate for the computing entity (step 508). Continuing the example, the first set of network ports are considered with respect to the second set of network ports. The applied rules serve to resolve conflicts and/or duplications. As a result of the application of the operations of step 508, a set of policy actions corresponding to the selected policy subcomponents is determined (step 510). In some cases, the policy actions are codified in the mapping rules of the policy subcomponents.

The policy aggregate generation technique 500 further identifies any conflicts that might exist between the policy actions of the policy subcomponents that comprise the policy aggregate (step 512). If conflicts exist (see “Yes” path of decision 514), then the conflicts between the policy actions are resolved (step 516). For example, a set of conflict resolution rules might be consulted to resolve the conflicts. When the conflicts are resolved according to step 516 or, when no conflicts were identified (see “No” path of decision 514), redundant policy actions from the policy actions are identified (step 518). As an example, a redundant policy action is a policy action that, when applied, produces no change to the then-current operating state of the subject computing entity. If there are redundant policy actions (see “Yes” path of decision 520), then the redundant policy actions are removed from the set of policy actions (step 522). When the redundant policy actions are removed according to step 522 or no redundant policy actions were identified (see “No” path of decision 520), then the reconciled set of policy actions are stored in association with the policy aggregate (step 524). The reconciled set of policy actions are available to be executed over the computing entity

Scenarios that illustrate implementations of the policy aggregate generation technique 500 and/or other herein disclosed techniques are disclosed as follows.

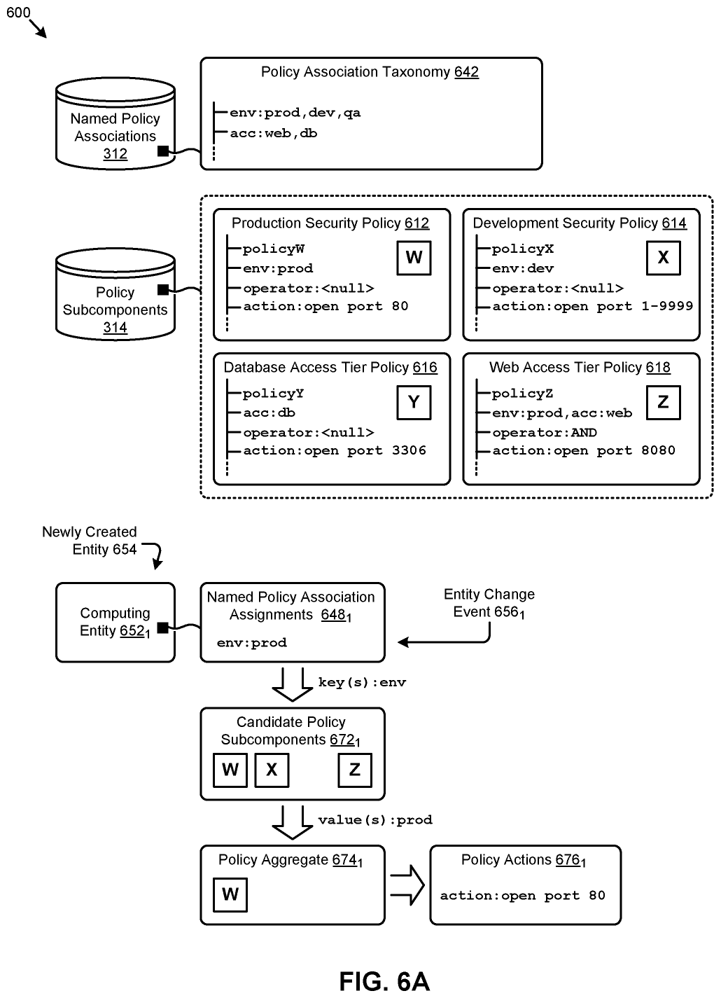

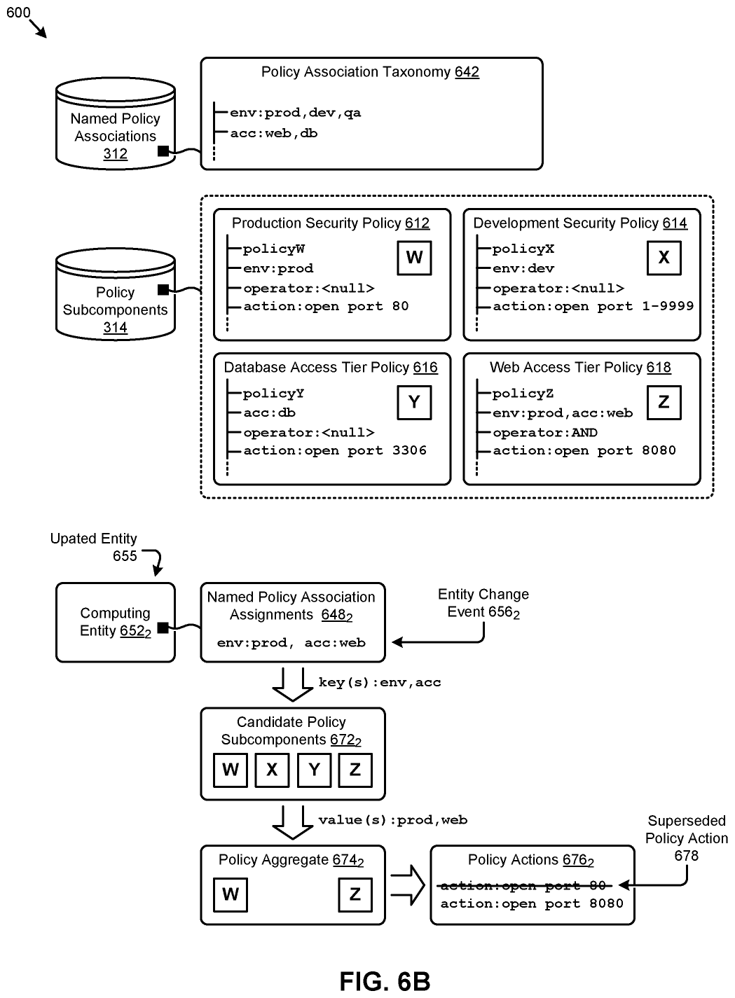

FIG. 6A and FIG. 6B illustrate a policy aggregate application scenario 600 as implemented in systems that facilitate entity-specific aggregation of policies that are enforced on computing entities in virtualized computing environments. As an option, one or more variations of policy aggregate application scenario 600 or any aspect thereof may be implemented in the context of the architecture and functionality of the embodiments described herein. The policy aggregate application scenario 600 or any aspect thereof may be implemented in any environment.

The embodiment shown in FIG. 6A depicts a policy association taxonomy 642 for a set of named policy associations 312 that comprises two keys: an “env” key corresponding to an entity environment characteristic, and an “acc” key corresponding to an entity access tier characteristic. The possible values for each key are also shown in the policy association taxonomy 642. Four examples of policy subcomponents 314 are also shown: a production security policy 612, a development security policy 614, a database access tier policy 616, and a web access tier policy 618. In accordance with the policy attributes 444 discussed as pertains to FIG. 4, the foregoing policy subcomponents each have a policy subcomponent identifier (e.g., “policyZ” for web access tier policy 618), a list of one or more named policy association key-value pairs (e.g., “env:prod, acc:web” for web access tier policy 618), a set of one or more operators to apply to the key-value pairs (e.g., “operator:AND” for web access tier policy 618), and a list of one or more policy actions (e.g., “action:open port 8080” for web access tier policy 618).

As can be observed in FIG. 6A, a computing entity 652₁ might be created with entity named policy association assignments 648₁ comprising the key-value pair “env:prod”. As a newly created entity 654, the appearance of the entity named policy association assignments 648₁ constitutes an entity change event 656₁. As such, according to the herein disclosed techniques, the key corresponding to the entity change event 656₁ (e.g., “env”) is used to determine a set of candidate policy subcomponents 672₁. Specifically, the key “env” is compared to the named policy association key-value pairs of the policy subcomponents to identify “policyW”, “policyX”, and “policyZ” as candidate policy subcomponents. This is due to the appearance of the key “env” in each of “policyW”, “policyX”, and “policyZ”, but not in “policyY”.

The value “prod” of the entity named policy association assignments 648₁ is then applied to the policy subcomponent attributes to select the policy subcomponents from the candidate policy subcomponents 672₁ to comprise a policy aggregate 674₁ for the computing entity 652₁. As shown, “policyW” matches the “env:prod” key-value pair of the entity named policy association assignments 648₁, however even though “policyZ”, does list the key/value pair “env”/“prod”, “policyZ” also includes the operator “AND” which is used to require that both the key/value pair “env”/“prod” as well the key/value pair “acc”/“web” be present in order to be considered a candidate match. As such only “policyW” is included in policy aggregate 674₁. The attributes of production security policy 612 (e.g., “policyW”) are then accessed to determine the reconciled policy actions 676₁ (e.g., “action:open port 80”).

Referring to FIG. 6B, the policy aggregate application scenario 600 continues. The example of FIG. 6B describes the policy association taxonomy 642 of the named policy associations 312, as well as the policy subcomponents 314 (e.g., production security policy 612, development security policy 614, database access tier policy 616, and web access tier policy 618), as earlier shown and described as pertains to FIG. 6A. As shown in FIG. 6B, the computing entity 652₁ of FIG. 6A might be updated, and thus become an updated entity 655 (e.g., computing entity 652₂). As shown, the updated entity 655 has a set of entity named policy association assignments 648₂ comprising a first key-value pair “env:prod” and a second key-value pair “acc:web”. Any change in the individual policies, and/or any change that modifies policy association assignments 648₂ constitutes an entity change event 656₂. As such, according to the herein disclosed techniques, the keys corresponding to the entity change event 656₂ (e.g., “env” and “acc”) are used to determine a set of candidate policy subcomponents 672₂. As can be observed, all policy subcomponents of FIG. 6B match one or both of the keys. The values “prod” and “web” of the entity named policy association assignments 648₂ are then applied to the policy subcomponent attributes to select the policy subcomponents from the candidate policy subcomponents 672₂ to comprise a policy aggregate 674₂ for the computing entity 652₂.

As shown, “policyW” and “policyZ” match the “env:prod” and “acc:web” key-value pairs of the entity named policy association assignments 648₂. Specifically, “policyW” matches the “env:prod” key-value pair, and “policyZ” match both the “env:prod” and “acc:web” key-value pairs in accordance with its “AND” operator. The attributes of production security policy 612 (e.g., “policyW”) and the web access tier policy 618 (e.g., “policyZ”) are accessed to determine the reconciled policy actions 676₂ (e.g., “action:open port 80” and “action:open port 8080”). Since the “open port 80” action has been earlier applied to the computing entity, then as a result of reconciliation, that action can be superseded, as depicted by the shown superseded policy action 678. The action “open port 8080” can then be executed for computing entity 652₂.

The foregoing example depicts merely one policy aggregate application scenario. In some cases, a set of default rules are implemented, which default rules might fire when there is some ambiguity or conflict in or between the rules themselves. Application of default rules might include firing a rule based on the nature or characteristics of the aggregate itself, and/or based on heuristics such as “prefer more permissive actions”, or such as “prefer more restrictive actions”. Selection of a heuristic to apply in a particular scenario might be based on the nature or characteristics of the aggregate itself.

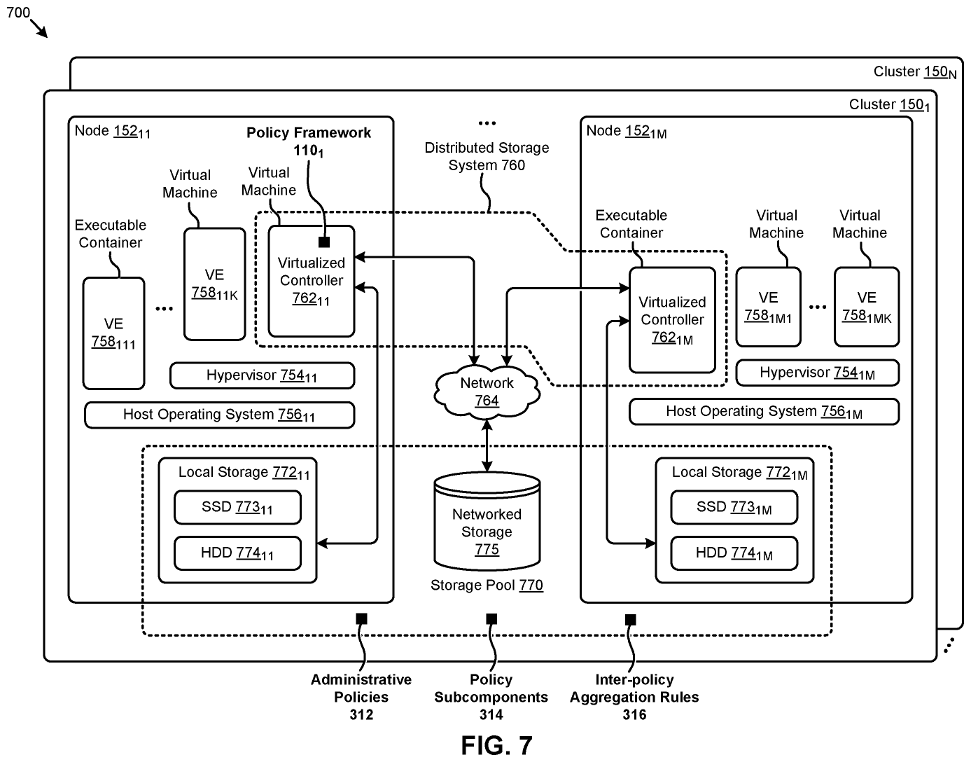

The foregoing discussion describes the herein disclosed techniques as implemented in a virtualized computing system. One embodiment of a distributed virtualization system in which embodiments of the present disclosure can be implemented is disclosed in the distributed virtualization system of FIG. 7.

FIG. 7 presents a distributed virtualization system 700 in which embodiments of the present disclosure can be implemented. As an option, one or more variations of distributed virtualization system 700 or any aspect thereof may be implemented in the context of the architecture and functionality of the embodiments described herein.

The shown distributed virtualization environment depicts various components associated with one instance of a distributed virtualization system (e.g., a hyperconverged distributed system) comprising a distributed storage system 760 that can be used to implement the herein disclosed techniques. Specifically, the distributed virtualization system 700 comprises multiple clusters (e.g., cluster 150₁, . . . , cluster 150_{N}) comprising multiple nodes that have multiple tiers of storage in a storage pool. Representative nodes (e.g., node 152₁₁, . . . , node 152_{1M}) and storage pool 770 associated with cluster 150₁ are shown. Each node can be associated with one server, multiple servers, or portions of a server. The nodes can be associated (e.g., logically and/or physically) with the clusters. As shown, the multiple tiers of storage include storage that is accessible through a network 764, such as a networked storage 775 (e.g., a storage area network or SAN, network attached storage or NAS, etc.). The multiple tiers of storage further include instances of local storage (e.g., local storage 772₁₁, . . . , local storage 772_{1M}). For example, the local storage can be within or directly attached to a server and/or appliance associated with the nodes. Such local storage can include solid state drives (SSD 773₁₁, . . . , SSD 773_{1M}), hard disk drives (HDD 774₁₁, . . . , HDD 774_{1M}), and/or other storage devices.

As shown, any of the nodes of the distributed virtualization system 700 can implement one or more user virtualized entities (e.g., VE 758₁₁₁, . . . , VE 758_{11K}, . . . , VE 758_{1M1}, . . . , VE 758_{1MK}), such as virtual machines (VMs) and/or containers. The VMs can be characterized as software-based computing “machines” implemented in a hypervisor-assisted virtualization environment that emulates the underlying hardware resources (e.g., CPU, memory, etc.) of the nodes. For example, multiple VMs can operate on one physical machine (e.g., node host computer) running a single host operating system (e.g., host operating system 756₁₁, . . . , host operating system 756_{1M}), while the VMs run multiple applications on various respective guest operating systems. Such flexibility can be facilitated at least in part by a hypervisor (e.g., hypervisor 754₁₁, . . . , hypervisor 754_{1M}), which hypervisor is logically located between the various guest operating systems of the VMs and the host operating system of the physical infrastructure (e.g., node).

As an example, hypervisors can be implemented using virtualization software that includes a hypervisor. In comparison, the containers (e.g., application containers or ACs) are implemented at the nodes in an operating system virtualization environment or container virtualization environment. The containers comprise groups of processes and/or resources (e.g., memory, CPU, disk, etc.) that are isolated from the node host computer and other containers. Such containers directly interface with the kernel of the host operating system (e.g., host operating system 756₁₁, . . . , host operating system 756_{1M}) without, in most cases, a hypervisor layer. This lightweight implementation can facilitate efficient distribution of certain software components, such as applications or services (e.g., micro-services). As shown, distributed virtualization system 700 can implement both a hypervisor-assisted virtualization environment and a container virtualization environment for various purposes.

Distributed virtualization system 700 also comprises at least one instance of a virtualized controller to facilitate access to storage pool 770 by the VMs and/or containers.

As used in these embodiments, a virtualized controller is a collection of software instructions that serve to abstract details of underlying hardware or software components from one or more higher-level processing entities. A virtualized controller can be implemented as a virtual machine, as a container (e.g., a Docker container), or within a layer (e.g., such as a layer in a hypervisor).

Multiple instances of such virtualized controllers can coordinate within a cluster to form the distributed storage system 760 which can, among other operations, manage the storage pool 770. This architecture further facilitates efficient scaling of the distributed virtualization system. The foregoing virtualized controllers can be implemented in distributed virtualization system 700 using various techniques. Specifically, an instance of a virtual machine at a given node can be used as a virtualized controller in a hypervisor-assisted virtualization environment to manage storage and I/O (input/output or IO) activities. In this case, for example, the virtualized entities at node 152₁₁ can interface with a controller virtual machine (e.g., virtualized controller 762₁₁) through hypervisor 754₁₁ to access the storage pool 770. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 760.

For example, a hypervisor at one node in the distributed storage system 760 might correspond to a first vendor's software, and a hypervisor at another node in the distributed storage system 760 might correspond to a second vendor's software. As another virtualized controller implementation example, containers (e.g., Docker containers) can be used to implement a virtualized controller (e.g., virtualized controller 762_{1M}) in an operating system virtualization environment at a given node. In this case, for example, the virtualized entities at node 152_{1M} can access the storage pool 770 by interfacing with a controller container (e.g., virtualized controller 762_{1M}) through hypervisor 754_{1M} and/or the kernel of host operating system 756_{1M}.

In certain embodiments, one or more instances of a policy framework can be implemented in the distributed storage system 760 to facilitate the herein disclosed techniques. Specifically, policy framework 110₁ can be implemented in the virtualized controller 762₁₁. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or their agents (e.g., a listener agent, an aggregator agent, etc.). As such, the implementation shown in FIG. 7 might correspond to a centralized implementation as earlier discussed. A distributed implementation is also possible in the distributed virtualization system 700. As further shown, instances of certain datastores (e.g., comprising named policy associations 312, policy subcomponents 314, and inter-policy aggregation rules 316) can be implemented in storage pool 770 to facilitate the herein disclosed techniques.

### Additional Embodiments of the Disclosure

### Additional Practical Application Examples

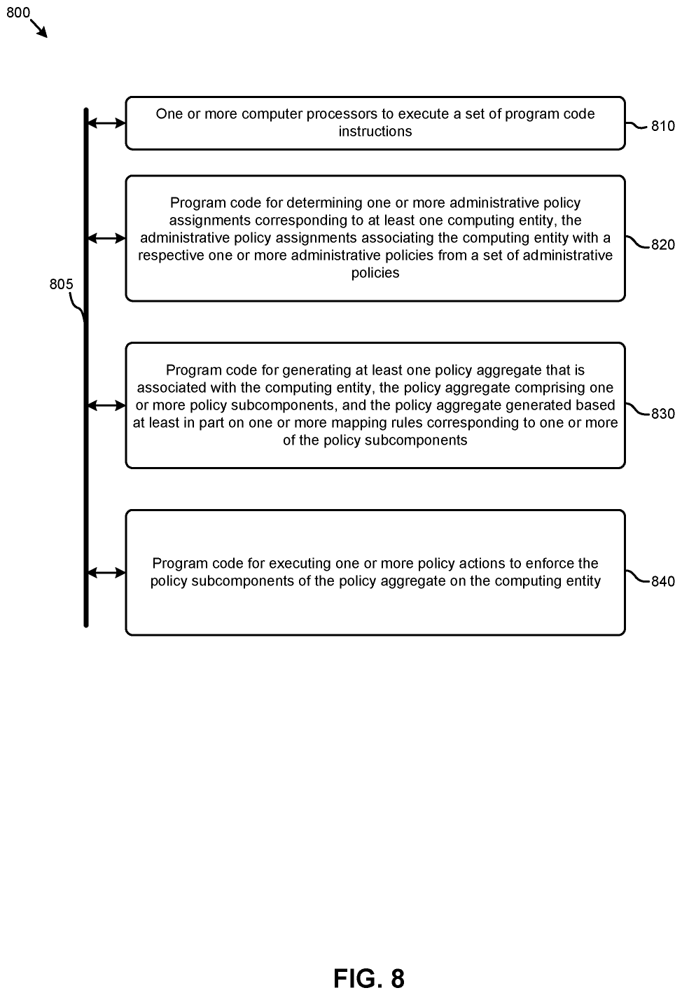

FIG. 8 depicts a system 800 as an arrangement of computing modules that are interconnected so as to operate cooperatively to implement certain of the herein-disclosed embodiments. This and other embodiments present particular arrangements of elements that, individually and/or as combined, serve to form improved technological processes that address managing large numbers of individual policies that are assigned to large numbers of computing entities in virtualized computing environments. The partitioning of system 800 is merely illustrative and other partitions are possible. As an option, the system 800 may be implemented in the context of the architecture and functionality of the embodiments described herein. Of course, however, the system 800 or any operation therein may be carried out in any desired environment. The system 800 comprises at least one processor and at least one memory, the memory serving to store program instructions corresponding to the operations of the system. As shown, an operation can be implemented in whole or in part using program instructions accessible by a module. The modules are connected to a communication path 805, and any operation can communicate with other operations over communication path 805. The modules of the system can, individually or in combination, perform method operations within system 800. Any operations performed within system 800 may be performed in any order unless as may be specified in the claims. The shown embodiment implements a portion of a computer system, presented as system 800, comprising one or more computer processors to execute a set of program code instructions (module 810) and modules for accessing memory to hold program code instructions to perform: determining one or more named policy association assignments corresponding to at least one computing entity, the named policy association assignments associating the computing entity with a respective one or more named policy associations (module 820); generating at least one policy aggregate that is associated with the computing entity, the policy aggregate comprising one or more policy subcomponents, and the policy aggregate generated based at least in part on one or more mapping rules corresponding to one or more of the policy subcomponents (module 830); and executing one or more policy actions to enforce the policy subcomponents of the policy aggregate on the computing entity (module 840).

Variations of the foregoing may include more or fewer of the shown modules. Certain variations may perform more or fewer (or different) steps, and/or certain variations may use data elements in more, or in fewer (or different) operations. Still further, some embodiments include variations in the operations performed, and some embodiments include variations of aspects of the data elements used in the operations.

### System Architecture Overview

### Additional System Architecture Examples

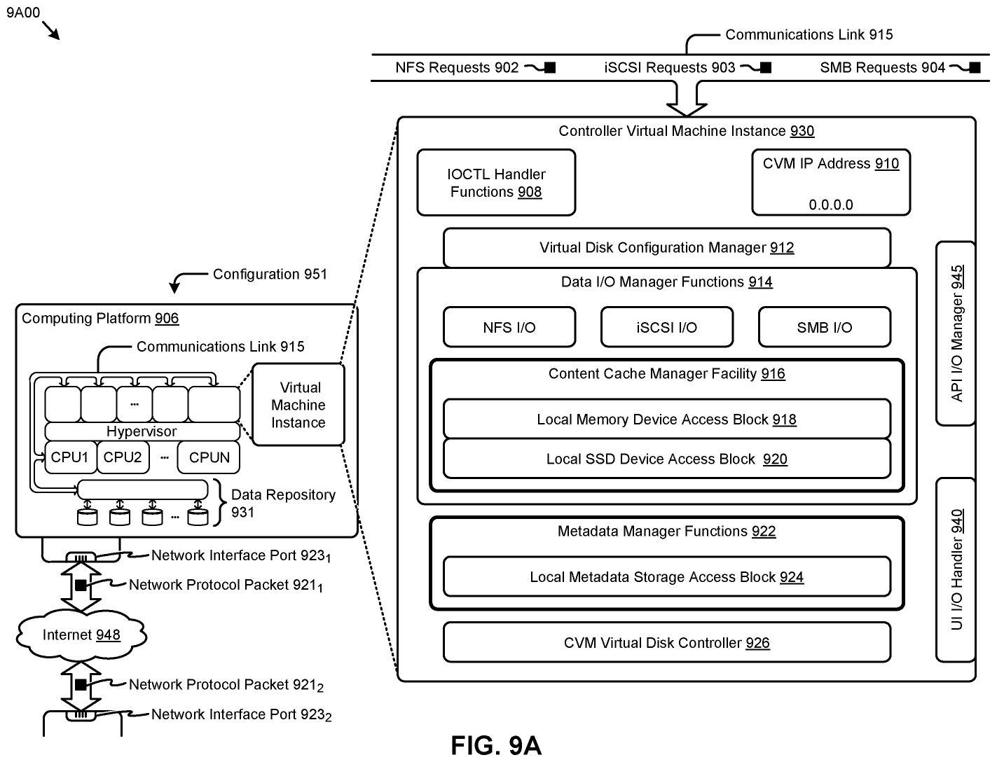

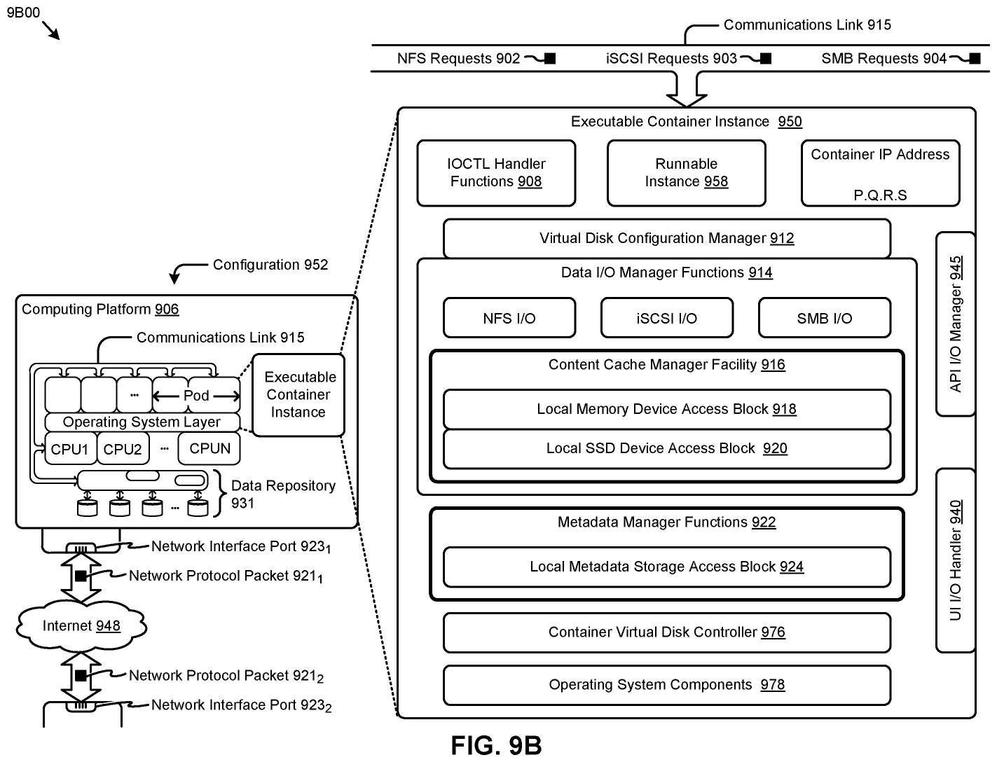

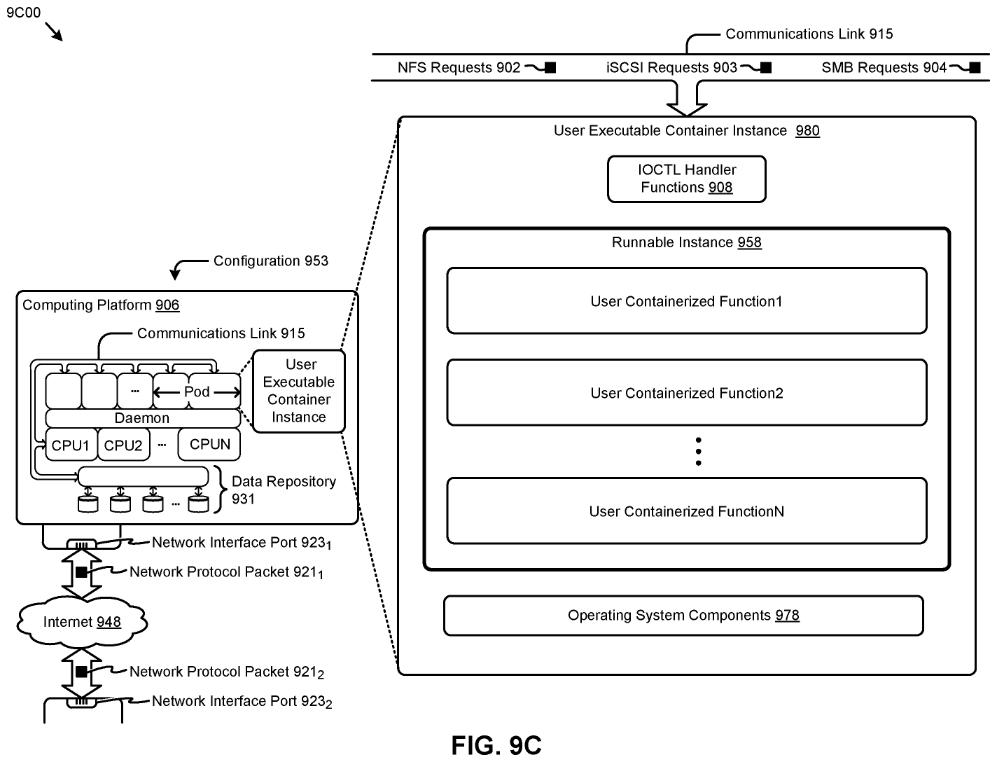

FIG. 9A depicts a virtualized controller as implemented by the shown virtual machine architecture 9A00. The heretofore-disclosed embodiments, including variations of any virtualized controllers, can be implemented in distributed systems where a plurality of networked-connected devices communicate and coordinate actions using inter-component messaging. Distributed systems are systems of interconnected components that are designed for, or dedicated to, storage operations as well as being designed for, or dedicated to, computing and/or networking operations. Interconnected components in a distributed system can operate cooperatively to achieve a particular objective, such as to provide high performance computing, high performance networking capabilities, and/or high performance storage and/or high capacity storage capabilities. For example, a first set of components of a distributed computing system can coordinate to efficiently use a set of computational or compute resources, while a second set of components of the same distributed storage system can coordinate to efficiently use a set of data storage facilities.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

As shown, virtual machine architecture 9A00 comprises a collection of interconnected components suitable for implementing embodiments of the present disclosure and/or for use in the herein-described environments. Moreover, virtual machine architecture 9A00 includes a virtual machine instance in configuration 951 that is further described as pertaining to controller virtual machine instance 930. Configuration 951 supports virtual machine instances that are deployed as user virtual machines, or controller virtual machines or both. Such virtual machines interface with a hypervisor (as shown). Some virtual machines include processing of storage I/O (input/output or IO) as received from any or every source within the computing platform. An example implementation of such a virtual machine that processes storage I/O is depicted as 930.

In this and other configurations, a controller virtual machine instance receives block I/O (input/output or IO) storage requests as network file system (NFS) requests in the form of NFS requests 902, and/or internet small computer storage interface (iSCSI) block IO requests in the form of iSCSI requests 903, and/or Samba file system (SMB) requests in the form of SMB requests 904. The controller virtual machine (CVM) instance publishes and responds to an internet protocol (IP) address (e.g., CVM IP address 910). Various forms of input and output (I/O or IO) can be handled by one or more IO control handler functions (e.g., IOCTL handler functions 908) that interface to other functions such as data IO manager functions 914 and/or metadata manager functions 922. As shown, the data IO manager functions can include communication with virtual disk configuration manager 912 and/or can include direct or indirect communication with any of various block IO functions (e.g., NFS IO, iSCSI IO, SMB IO, etc.).

In addition to block IO functions, configuration 951 supports IO of any form (e.g., block IO, streaming IO, packet-based IO, HTTP traffic, etc.) through either or both of a user interface (UI) handler such as UI IO handler 940 and/or through any of a range of application programming interfaces (APIs), possibly through API IO manager 945.

Communications link 915 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as disk drives or tape drives. Volatile media includes dynamic memory such as random access memory. As shown, controller virtual machine instance 930 includes content cache manager facility 916 that accesses storage locations, possibly including local dynamic random access memory (DRAM) (e.g., through local memory device access block 918) and/or possibly including accesses to local solid state storage (e.g., through local SSD device access block 920).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of external data repository 931, which in turn can be formatted into any one or more storage areas, and which can comprise parameterized storage accessible by a key (e.g., a filename, a table name, a block address, an offset address, etc.). External data repository 931 can store any forms of data and may comprise a storage area dedicated to storage of metadata pertaining to the stored forms of data. In some cases, metadata can be divided into portions. Such portions and/or cache copies can be stored in the external storage data repository and/or in a local storage area (e.g., in local DRAM areas and/or in local SSD areas). Such local storage can be accessed using functions provided by local metadata storage access block 924. External data repository 931 can be configured using CVM virtual disk controller 926, which can in turn manage any number or any configuration of virtual disks.

Execution of the sequences of instructions to practice certain embodiments of the disclosure are performed by one or more instances of a software instruction processor, or a processing element such as a data processor, or such as a central processing unit (e.g., CPU1, CPU2, . . . , CPUN). According to certain embodiments of the disclosure, two or more instances of configuration 951 can be coupled by communications link 915 (e.g., backplane, LAN, PSTN, wired or wireless network, etc.) and each instance may perform respective portions of sequences of instructions as may be required to practice embodiments of the disclosure.

The shown computing platform 906 is interconnected to the Internet 948 through one or more network interface ports (e.g., network interface port 923₁ and network interface port 923₂). Configuration 951 can be addressed through one or more network interface ports using an IP address. Any operational element within computing platform 906 can perform sending and receiving operations using any of a range of network protocols, possibly including network protocols that send and receive packets (e.g., network protocol packet 921₁ and network protocol packet 921₂).

Computing platform 906 may transmit and receive messages that can be composed of configuration data and/or any other forms of data and/or instructions organized into a data structure (e.g., communications packets). In some cases, the data structure includes program code instructions (e.g., application code) communicated through the Internet 948 and/or through any one or more instances of communications link 915. Received program code may be processed and/or executed by a CPU as it is received and/or program code may be stored in any volatile or non-volatile storage for later execution. Program code can be transmitted via an upload (e.g., an upload from an access device over the Internet 948 to computing platform 906). Further, program code and/or the results of executing program code can be delivered to a particular user via a download (e.g., a download from computing platform 906 over the Internet 948 to an access device).

Configuration 951 is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (e.g., LAN or virtual LAN (VLAN)) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

A module as used herein can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to managing entity-specific, aggregated policies that are enforced on computing entities in virtualized computing environments. In some embodiments, a module may include one or more state machines and/or combinational logic used to implement or facilitate the operational and/or performance characteristics pertaining to management of entity-specific, aggregated policies.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of performing entity-specific aggregated policy management. Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to entity-specific aggregation of policies that are enforced on computing entities in virtualized computing environments, and/or for improving the way data is manipulated when performing computerized operations pertaining to forming a tier of named policy associations that are assigned to computing entities for automated management of entity-specific policy aggregates and their relationships to individual policy constituents in rapidly-changing computing environments.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT”, issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT”, issued on Oct. 1, 2013, which is hereby incorporated by reference in its entirety.

FIG. 9B depicts a virtualized controller implemented by containerized architecture 9B00. The containerized architecture comprises a collection of interconnected components suitable for implementing embodiments of the present disclosure and/or for use in the herein-described environments. Moreover, the shown containerized architecture 9B00 includes an executable container instance in configuration 952 that is further described as pertaining to executable container instance 950. Configuration 952 includes an operating system layer (as shown) that performs addressing functions such as providing access to external requestors via an IP address (e.g., “P.Q.R.S”, as shown). Providing access to external requestors can include implementing all or portions of a protocol specification (e.g., “http:”) and possibly handling port-specific functions.

The operating system layer can perform port forwarding to any executable container (e.g., executable container instance 950). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance (e.g., a Docker container instance) can serve as an instance of an application container. Any executable container of any sort can be rooted in a directory system, and can be configured to be accessed by file system commands (e.g., “ls” or “ls-a”, etc.). The executable container might optionally include operating system components 978, however such a separate set of operating system components need not be provided. As an alternative, an executable container can include runnable instance 958, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, container virtual disk controller 976. Such a container virtual disk controller can perform any of the functions that the aforementioned CVM virtual disk controller 926 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 9C depicts a virtualized controller implemented by a daemon-assisted containerized architecture 9C00. The containerized architecture comprises a collection of interconnected components suitable for implementing embodiments of the present disclosure and/or for use in the herein-described environments. Moreover, the shown instance of daemon-assisted containerized architecture 9C00 includes a user executable container instance in configuration 953 that is further described as pertaining to user executable container instance 980. Configuration 953 includes a daemon layer (as shown) that performs certain functions of an operating system.

User executable container instance 980 comprises any number of user containerized functions (e.g., user containerized function1, user containerized function2, . . . , user containerized functionN). Such user containerized functions can execute autonomously, or can be interfaced with or wrapped in a runnable object to create a runnable instance (e.g., runnable instance 958). In some cases, the shown operating system components 978 comprise portions of an operating system, which portions are interfaced with or included in the runnable instance and/or any user containerized functions. In this embodiment of a daemon-assisted containerized architecture, the computing platform 906 might or might not host operating system components other than operating system components 978. More specifically, the shown daemon might or might not host operating system components other than operating system components 978 of user executable container instance 980.

The virtual machine architecture 9A00 of FIG. 9A and/or the containerized architecture 9B00 of FIG. 9B and/or the daemon-assisted containerized architecture 9C00 of FIG. 9C can be used in any combination to implement a distributed platform that contains multiple servers and/or nodes that manage multiple tiers of storage, where the tiers of storage might be formed using the shown data repository 931 and/or any forms of network accessible storage. As such, the multiple tiers of storage may include storage that is accessible over communications link 915. Such network accessible storage may include cloud storage or networked storage (e.g., a SAN or storage area network). Unlike prior approaches, the presently-discussed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In example embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

Any one or more of the aforementioned virtual disks (or “vDisks”) can be structured from any one or more of the storage devices in the storage pool. As used herein, the term “vDisk” refers to a storage abstraction that is exposed by a controller virtual machine or container to be used by another virtual machine or container. In some embodiments, the vDisk is exposed by operation of a storage protocol such as iSCSI or NFS or SMB. In some embodiments, a vDisk is mountable. In some embodiments, a vDisk is mounted as a virtual storage device.

In example embodiments, some or all of the servers or nodes run virtualization software. Such virtualization software might include a hypervisor (e.g., as shown in configuration 951 of FIG. 9A) to manage the interactions between the underlying hardware and user virtual machines or containers that run client software.

Distinct from user virtual machines or user executable containers, a special controller virtual machine (e.g., as depicted by controller virtual machine instance 930) or as a special controller executable container is used to manage certain storage and I/O activities. Such a special controller virtual machine is referred to as a “CVM”, or as a controller executable container, or as a service virtual machine (SVM), or as a service executable container, or as a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines—above the hypervisors—thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

In the foregoing specification, the disclosure has been described with reference to specific embodiments thereof. It will however be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A method for aggregating a plurality of policies to enforce on computing entities, the method comprising:
determining one or more policy association assignments corresponding to at least one computing entity;
generating at least one policy aggregate that is associated with the computing entity, the at least one policy aggregate comprising two or more policy subcomponents;
reconciling the at least one policy aggregate based at least in part on one or more mapping rules that are applied to the two or more policy subcomponents; and
executing one or more policy actions to enforce at least some of the plurality of policies.

2. The method of claim 1, further comprising detecting at least one change to one or more of the policy association assignments, and wherein the determining of the policy association assignments corresponding to the at least one computing entity is responsive to detecting the change.

3. The method of claim 2, wherein the change is invoked by creating the computing entity or updating the computing entity.

4. The method of claim 1, further comprising identifying one or more conflicts between two or more of the policy subcomponents.

5. The method of claim 4, further comprising resolving at least one of the conflicts.

6. The method of claim 5, wherein one or more conflict resolution rules are applied to resolve the at least one of the conflicts.

7. The method of claim 1, further comprising identifying one or more redundant policy actions from the policy actions.

8. The method of claim 7, further comprising removing the redundant policy actions from the policy actions prior to executing the policy actions.

9. The method of claim 1, wherein the policy associations correspond to one or more entity operational characteristics.

10. The method of claim 1, wherein the policy associations are defined at least in part by a taxonomy comprising key-value pairs.

11. The method of claim 1, further comprising updating a state of an entity with a compliance indication.

12. The method of claim 11, wherein the compliance indication indicates whether the entity is compliant with a set of policies pertaining to the entity.

13. A computer readable medium, embodied in a non-transitory computer readable medium, the non-transitory computer readable medium having stored thereon a sequence of instructions which, when stored in memory and executed by one or more processors causes the one or more processors to perform a set of acts for aggregating a plurality of policies to enforce on computing entities, the set of acts comprising:
determining one or more policy association assignments corresponding to at least one computing entity;
generating at least one policy aggregate that is associated with the computing entity, the at least one policy aggregate comprising two or more policy subcomponents;
reconciling the at least one policy aggregate based at least in part on one or more mapping rules that are applied to the two or more policy subcomponents; and
executing one or more policy actions to enforce at least some of the plurality of policies.

14. The computer readable medium of claim 13, further comprising instructions which, when stored in memory and executed by the one or more processors causes the one or more processors to perform acts of detecting at least one change to one or more of the policy association assignments, and wherein the determining of the policy association assignments corresponding to the at least one computing entity is responsive to detecting the change.

15. The computer readable medium of claim 14, wherein the change is invoked by creating the computing entity or updating the computing entity.

16. The computer readable medium of claim 13, further comprising instructions which, when stored in memory and executed by the one or more processors causes the one or more processors to perform acts of identifying one or more conflicts between two or more of the policy subcomponents.

17. The computer readable medium of claim 16, further comprising instructions which, when stored in memory and executed by the one or more processors causes the one or more processors to perform acts of resolving at least one of the conflicts.

18. The computer readable medium of claim 17, wherein one or more conflict resolution rules are applied to resolve the at least one of the conflicts.

19. A system for aggregating a plurality of policies to enforce on computing entities, the system comprising:
a storage medium having stored thereon a sequence of instructions; and
one or more processors that execute the instructions to cause the one or more processors to perform a set of acts, the set of acts comprising,
determining one or more policy association assignments corresponding to at least one computing entity;
generating at least one policy aggregate that is associated with the computing entity, the at least one policy aggregate comprising two or more policy subcomponents;
reconciling the at least one policy aggregate based at least in part on one or more mapping rules that are applied to the two or more policy subcomponents; and
executing one or more policy actions to enforce at least some of the plurality of policies.

20. The system of claim 19, wherein the policy associations correspond to one or more entity operational characteristics.
